(19) United States
(12) Patent Application Publication
(10) Pub. No.: US 2025/0324189 A1
(43) Pub. Date: Oct. 16, 2025

(54) AUDIO REPRODUCTION SYSTEM AND METHOD OF OPERATION

(71) Applicant: Sony Interactive Entertainment Inc., Tokyo (JP)

(72) Inventors: Jun Yen Leung, London (GB); Patrick John Connor, London (GB); Maria Chiara Monti, London (GB); Lawrence Green, London (GB); Maurizio Cerrato, London (GB); Rajeev Gupta, London (GB)

(73) Assignee: Sony Interactive Entertainment Inc., Tokyo (JP)

(21) Appl. No.: 19/097,919

(22) Filed: Apr. 2, 2025

(30) Foreign Application Priority Data
Apr. 10, 2024 (GB) 2405076.7

(51) Int. Cl. H04R 1/10

(52) U.S. Cl. CPC H04R 1/1091; H04R 1/1041

(57) ABSTRACT

An audio reproduction system for reproducing an audio signal comprises headphones, comprising in turn at least a first loudspeaker, and at least a first airflow generator configured to generate airflow toward a respective ear of a user of the headphones; and the system also comprises an airflow controller, configured to control the airflow generated by the at least first airflow generator, responsive to at least a first aspect of the audio signal.

### CROSS REFERENCE

The present application claims priority to United Kingdom (GB) Application No. GB2405076.7, filed 10 Apr. 2024, the contents of which is incorporated by reference herein in its entirety for all purposes.

### BACKGROUND OF THE INVENTION

### Field of the invention

The present invention relates to an audio reproduction system and a method of operation.

### Description of the Prior Art

Traditionally, headphones focus on providing high-fidelity audio reproduction. Some headphones also include noise reduction processes to limit interruptions from ambient noise, or provide so-called spatial or binaural reproduction the improves the sense of spatial separation between sound sources in a recording. These features can greatly increase the impact of recorded media, in particular for audio and vocals notionally situated at a significant distance from other parts of the soundstage, and/or close to the user's ear. One notable use of this is for so-called autonomous sensory meridian response (‘ASMR’) audio and video, where a voice, or audio associated with certain actions, can trigger a pleasant tingling or goose-bump sensation, typically on the scalp, back of the head, and/or neck.

The present invention similarly seeks to enhance this impact.

### SUMMARY OF THE INVENTION

Various aspects and features of the present invention are defined in the appended claims and within the text of the accompanying description.

In a first aspect, an audio reproduction system is provided in accordance with claim 1.

In another aspect, a method of audio reproduction is provided in accordance with claim 14.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 is a schematic diagram of a system comprising an audio reproduction system in accordance with embodiments of the present description.

FIG. 2 is a schematic diagram of a part of a pair of headphones in accordance with embodiments of the present description.

FIG. 3 is a schematic diagram of a part of a pair of headphones in accordance with embodiments of the present description.

FIG. 4 is a flow diagram of a method of operation of an audio reproduction system in accordance with embodiments of the present description.

### WRITTEN DESCRIPTION

An audio reproduction system and a method of operation are disclosed. In the following description, a number of specific details are presented in order to provide a thorough understanding of the embodiments of the present invention. It will be apparent, however, to a person skilled in the art that these specific details need not be employed to practice the present invention. Conversely, specific details known to the person skilled in the art are omitted for the purposes of clarity where appropriate.

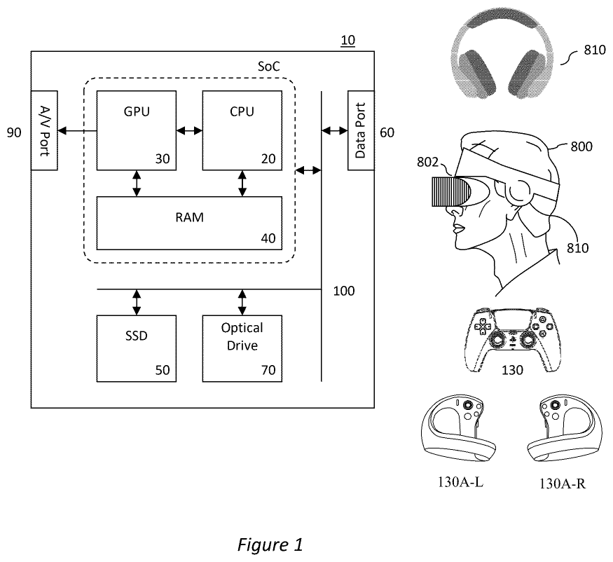

Referring now to the drawings, wherein like reference numerals designate identical or corresponding parts throughout the several views, FIG. 1 shows as an example of an entertainment system 10 a computer or console.

The entertainment system 10 comprises a central processor or CPU 20. The entertainment system also comprises a graphical processing unit or GPU 30, and RAM 40. Two or more of the CPU, GPU, and RAM may be integrated as a system on a chip (SoC).

Further storage may be provided by a disk 50, either as an external or internal hard drive, or as an external solid state drive, or an internal solid state drive.

The entertainment device may transmit or receive data via one or more data ports 60, such as a USB port, Ethernet® port, Wi-Fi® port, Bluetooth® port or similar, as appropriate. It may also optionally receive data via an optical drive 70.

Audio/visual outputs from the entertainment device are typically provided through one or more A/V ports 90 or one or more of the data ports 60.

Where components are not integrated, they may be connected as appropriate either by a dedicated data link or via a bus 100.

An example of a device for displaying images output by the entertainment system is a head mounted display ‘HMD’ 802, worn by a user 800.

Interaction with the system is typically provided using one or more handheld controllers 130, and/or one or more VR controllers (130A-L,R) in the case of the HMD.

The entertainment device may be used for playing games or consuming other content, such as movies.

When playing such games or optionally other content, the user may receive audio from headphones 810 when viewing the content on a static display such as a television, or similarly receiving audio from headphones 810 when viewing content on a head mounted display (‘HMD’) 802. In this latter case, the headphones may be separate or separable from the HMD, or may be integral with it.

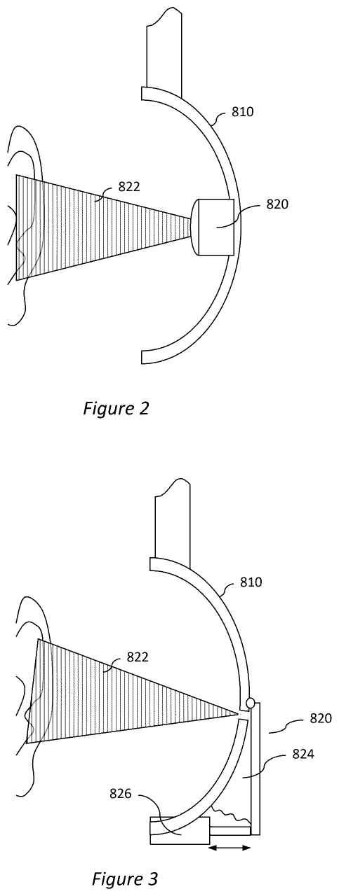

Referring now to FIG. 2, in addition to reproducing sound, in embodiments of the present description headphones 810 are configured to output puffs of air 822 responsive to an estimate of the amount of air that would be output by the generation of a corresponding reproduced sound.

In particular, the amount of air output by speaking/singing various syllables or phonemes.

This requires a controllable air source 820, and association with a means to estimate the amount to output.

The controllable air source 820 may comprise one or more of the following.

Firstly, in example embodiments of the description, a canister of compressed air (not shown) is connected via a solenoid valve to a hose that terminates within the headphone cup pointing toward the user's ear in normal use. An air flow control processor (e.g. CPU 20, under suitable software instruction) can then control the solenoid to release a puff or flow of air toward the user's ear, responsive to the estimated amount of air corresponding to the sound (references to ‘air flow’, ‘puff’, or the like may be treated as equivalent herein). It will be appreciated that for stereo headphones, there may be respective solenoids and hoses for each of the left and right headphone cups, either linked to a common canister of compressed air, or to respective canisters. It will also be appreciated that for respective canisters and valves, these could be positioned to release air towards the user's ear directly without the need for hosing.

The above arrangements are mechanically simple but have the disadvantage of requiring the replacement of one or more canisters over time in order to maintain the functionality.

Accordingly, in example embodiments of the description, such canisters are functionally replaced by one or more reservoirs (not shown), pressurised to provide a puff or flow of air via a solenoid valve as described previously. In this case the or each reservoir is pressurised by an air pump or a fan. The air pump may be manual (e.g. the user can attach a pump like a bicycle pump to pressurise the reservoir before listening use), or can be electrically powered before or during listening use.

In the case of an electrically powered pump or fan, it may pressurise the or each reservoir when the headphones are turned on and/or put on, preferably prior to audio reproduction.

In the event that more pressure is needed (e.g. due to ongoing output of air depleting reservoir pressurisation), the electric pump or fan may optionally function responsive to the audio, for example operating briefly during a bass beat, and/or when the audio level is above a threshold. Also optionally the electric pump or fan may not function when the solenoid valve is allowing air out of the reservoir, so that there is no direct acoustic coupling of the operating pump or fan to the user's ear via the air. These mitigations reduce the scope for the pump or fan's operation to affect the reproduced audio for the user.

The reservoir(s) may optionally be located within the headphone cup(s), or form part of the cushioning around or on the user's ears or over their head, depending on the specific headphone design.

Furthermore, the pump or fan may be acoustically decoupled from the headphones, for example via a flexible feed hose into the reservoir(s), and/or via damped mounts (for example mounts with a resonance well below the operating frequency of the pump or fan).

The above arrangements remove the need for replaceable canisters but may cause unwanted sound due to the pump or fan, which is typically driven by a motor that will generate periodic/tonal signals that can travel through the air and/or the structure of the headphones to the user's ear.

Accordingly, and referring now to FIG. 3, in example embodiments of the description, the pump may be replaced by a bellows 824 driven by an actuator 826. A small bellows may be constructed from two hinged rigid plates and an elastomeric/resilient bag between them, the plates being opened or closed by the actuator. One of the plates may optionally be part of the headphone cup (whether internally or externally) as shown in FIG. 3. The bellows may feed the or each reservoir or, as illustrated in FIG. 3, directly generate the air puff or flow based on suitable control of the actuator, without the need for an intermediate reservoir, to operate as the airflow generator 820. Again the actuator itself may be resiliently mounted to reduce acoustic coupling to the headphones. However in this case typically the actuator will not generate periodic/tonal signals and so the issue of generated sound as a by-product of the air puff or flow generation is reduced.

One advantage of a bellows is that the actuator can provide continuously variable airflow/puff as it compresses the bellows, based on a control signal, and hence more accurately control the airflow/puff envelope. The bellows can be rapidly re-inflated via a valve when the actuator pushes them back open.

In embodiments of the description, as noted previously herein control of the solenoid valve, bellows actuator, or other airflow generation/release mechanism is by an airflow control processor (for example CPU 20 under suitable software instruction).

This airflow control processor may be included within the headphones 810, or within a signal source device such as a videogame console 10, or a PC, music player, phone or tablet, smart TV, hi-fi amplifier or tuner, or the like (not shown).

In a first instance, the airflow control processor can control airflow responsive to the amplitude of the audio. Hence in this case the airflow/puff is typically proportional to the audio amplitude.

Optionally, this may be limited to amplitude in one or more specific audio bands; hence for example the air flow may be responsive to amplitude within a bass frequency range associated for example with bass drum beats, and/or with higher frequencies associated is plosive vocals or hi-hat/cymbal sounds, or with a band associated with voiced sounds.

Alternatively or in addition a voice activity detector ‘VAD’ (typically based on detecting voiced pitch, and optionally characteristic features of formants) may be used to limit the control to be responsive to amplitude predominantly of spoken/sung voices.

Either of the above approaches may alternatively or in addition be responsive to amplitude gradient; hence a sudden increase in amplitude can be associated with a corresponding airflow/puff responsive to the gradient of the increase, and optionally also responsive to the amplitude.

Hence in this first instance, the airflow control processor may respond directly to properties of the reproduced audio. Advantageously, this is computationally simple to implement, and also low latency—typically the audio does not need to be buffered to perform the analysis.

Optionally, however the audio can be buffered (e.g. for gradient detection, and/or of voice activity detection). In these cases, the buffer, and hence the delay, can be small as neither gradient detection or VAD require many samples.

Optionally alternatively or in addition the audio can be buffered & delayed to synchronise the arrival of the audio at the ear with the slower generation and/or propagation of the output airflow or puff within the headphone cup(s). Again, the delay will be quite short as the distance from the airflow source to the car is very short within the headphones.

The buffers can serve to improve the relative timing of the audio and air flow at the user's ear. Meanwhile, where the audio is also associated with a video signal, it may be necessary to either buffer the video signal, or read the audio signal in advance, by an amount corresponding to the delay(s) associated with the buffer(s).

Whilst the above instance generates air flow/puffs responsive to properties of any audio, there is scope for a more selective output.

Hence in a second instance, the airflow control processor implements phoneme identification using any suitable known technique; this approach acknowledges that, separate to audio amplitude or gradient, a person expels more air from their mouth saying ‘pa’ than they do saying ‘ma’, for example.

Accordingly, a database may be built by recording real people saying different test phonemes to a microphone and co-located airflow sensor, so that airflow levels corresponding to respective phonemes can be associated within the database. As a refinement, some phoneme pairs may also be identified where the combination of phonemes alters the airflow associated with at least one of them.

In this case the airflow control processor can then identify phonemes within the audio signal, and generate air flows/puffs that more accurately reflect what would be output and felt by the user if those phonemes were uttered by a real person near the user's ear.

In this case, again the audio may need to be buffered in order to perform the phoneme or phone-pair identification. Phonemes typically last between about 40 and 150 milliseconds, and so the audio buffering would need to safely accommodate this (and possibly two phonemes, if pairs are considered). Again also a short buffer delay may optionally be used to account for the different generation/propagation times of audio and air flow. Hence again where the audio is also associated with a video signal, it may be necessary to either buffer the video signal, or read the audio signal in advance, by an amount corresponding to the delay(s) associated with the buffer(s).

Nonetheless, it will be appreciated that the buffers/delays required for phoneme analysis are likely to be larger than for a direct response to audio properties such as amplitude/gradient.

Accordingly, to avoid the processing time inherent in needing to process at least one syllable/phoneme when received, optionally the analysis may be performed in advance for a recorded track and provided as timed metadata, either multiplexed with the audio, embedded in one or more suitable data fields of the audio format, or provided in a separate stream.

This metadata may take the form of lyrics (with the correspondence between syllables and/or syllable pairs in the lyrics, and airflow/puffs, then associated within a database)—this approach has the advantage that many audio platforms are already capable of reproducing lyrics in synchronisation with audio, and consequently also such lyrics with timing data arc readily available for a large number of works.

The metadata may alternatively or in addition comprise similarly timed phoneme identifiers, e.g. to remove any potential ambiguities in the lyrics, with the phoneme identifiers and/or pairs thereof and airflow/puffs associated within a database. In this case, the phoneme identifiers can be derived in advance using any suitable known technique, either from the audio itself and/or from the lyrics where available.

The metadata may alternatively or in addition comprise similarly timed airflow/puff data, e.g. for direct use by the airflow control processor. In this case, the airflow/puff data can be derived in advance for the recorded track using any of the techniques described herein.

It will be appreciated that phoneme identifiers or airflow/puff data may need to be generated specifically for the techniques herein, whilst as noted above lyrics may be more generally available.

Finally, in a third instance the airflow control processor uses a trained machine learning system to relate data inputs to air flow control outputs. Typically this will result in similar behaviour to the phoneme identification approach, but with smaller delays. The data inputs may comprise one or more of audio data, lyric data, and phoneme data.

In this case, a machine learning system may be trained on an input representation of an audio signal; for example based on the last second or less of audio. The representation may be in the time domain or the frequency domain, or comprise components from both. A typical representation may comprise a Fourier spectrum of the audio, a Mel-spectrum (a Fourier spectrum with different frequency bins, becoming wider at higher frequencies), or a cepstrum or Mel-cepstrum (the Fourier spectrum of a Fourier spectrum or a Mel-spectrum). The spectra may be weighted to favour higher frequencies normally associated with plosives. Other parametric descriptors may include a VAD flag, the base frequency associated with any formant in the audio, and the like.

Alternatively or in addition, the machine learning system may be trained on an input representation of lyrics, such as for example a syllable duo (preceding and current syllable) or syllable triple (preceding, current and next syllable), optionally with a null syllable to denote word breaks or similar pauses. The same principle can be used for an input representation of phonemes.

The target output can be a value representative of airflow, for example measured coincident with a microphone used to obtain the audio signal. It will be appreciated that the previously discussed database of real people saying different test phonemes to a microphone and co-located airflow sensor may be used for this purpose. More generally, synchronised recordings of people vocalising (e.g. talking, signing, and the like) to a microphone, and/or the corresponding lyrics and/or phonemes, can be used to generate the input training data, whist an airflow sensor co-located with the microphone, and/or airflow data, can be used to generate the target training data.

For audio inputs, the machine learning system can take advantage of preceding audio (e.g. in the last second or less) to predict/detect airflow for audio components such as plosives like the ‘p’ of ‘pa’ quickly when they occur. It will also be appreciated that for an audio representation corresponding to a second or less, then if a delay buffer is used the notional ‘current’ moment can be any point in that second, and the target can be the airflow value for that point. Hence the machine learning system can be trained to output airflow data for any set combination of preceding and/or following audio input representation, to select a trade-off between delay and output accuracy.

It will be appreciated that potentially lyric metadata or phoneme metadata can provide further context to the audio input, for example indicating pre- and post-context for the current audio moment and so potentially reducing the amount of audio (and buffering) required.

Notably, a machine learning model, based on one or more of audio, lyrics, or phonemes, can infer airflow/puff solutions for combinations of audio, lyrics, or phonemes (as appropriate) not encountered before.

The use of lyrics (or phonemes) with a suitable associated database of airflow/puff data, or a machine learning model based on lyrics (or phonemes) as inputs and airflow/puff data as targets may be sufficient to provide a good generation of airflow/puff in response to recorded vocalisations. However, use of a machine learning model based on audio can also capture variations in pronunciation and in particular emphasis in the performer's utterances that are not captured by the lyrics or phonemes alone, allowing for greater or lesser airflow/puff for ostensibly the same syllable/phoneme depending on the performance.

This benefit can optionally be enhanced by having a machine learning model generated using audio associated with a particular performer in order to more accurately reflect their individual airflow/puff characteristics, and the relevant machine learning model could be selected in response to artist metadata associated with the content being played back (with a generic model used where no specific model is available).

Accordingly, the airflow control processor can use one or more of the above techniques, based on audio (e.g. amplitude and/or gradient), lyrics, phonemes, or machine learning outputs responsive to any of these, to estimate the airflow/puff, if any, to output to accompany a reproduced sound, optionally with a delay to account for any processing and optionally for the different propagations speeds of sound and air puffs within the headphone cups.

All of these techniques can be used with recorded content, and some (e.g. based on audio processing or on-the-fly phoneme recognition) can be used for live content.

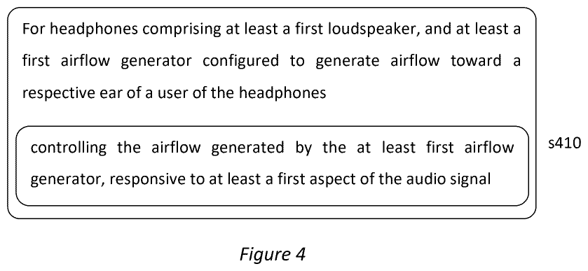

Turning now to FIG. 4, in a summary embodiment of the present description, a method of audio reproduction for reproducing an audio signal, comprises the following.

For headphones comprising in turn at least a first loudspeaker, and at least a first airflow generator configured to generate airflow toward a respective car of a user of the headphones, as described elsewhere herein, the method comprises the step s410 of controlling the airflow generated by the at least first airflow generator, responsive to at least a first aspect of the audio signal.

It will be apparent to a person skilled in the art that variations in the above method corresponding to operation of the various embodiments of the apparatus as described and claimed herein are considered within the scope of the present invention.

It will also be appreciated that the above method may be carried out on hardware suitably adapted as applicable by software instruction or by the inclusion or substitution of dedicated hardware.

Thus the required adaptation to existing parts of an equivalent device may be implemented in the form of a computer program product comprising processor implementable instructions stored on a non-transitory machine-readable medium such as a floppy disk, optical disk, hard disk, solid state disk, PROM, RAM, flash memory or any combination of these or other storage media, or realised in hardware as an ASIC (application specific integrated circuit) or an FPGA (field programmable gate array) or other configurable circuit suitable to use in adapting the conventional equivalent device. Separately, such a computer program may be transmitted via data signals on a network such as an Ethernet, a wireless network, the Internet, or any combination of these or other networks.

Accordingly, and referring again to FIGS. 1-3, in a summary embodiment of the present description, an audio reproduction system for reproducing an audio signal comprises:

Headphones 810, comprising in turn at least a first loudspeaker (not shown); and at least a first airflow generator (820) configured to generate airflow (822) toward a respective car of a user of the headphones, as described elsewhere herein; and

An airflow controller (for example CPU 20 or a corresponding CPU in the headphones), configured (for example by suitable software instruction) to control the airflow generated by the at least first airflow generator, responsive to at least a first aspect of the audio signal, as described elsewhere herein.

Instances of this summary embodiment implementing the methods and techniques described herein (for example by use of suitable software instruction) are envisaged within the scope of the application, including but not limited to that:
the at least a first airflow generator (820) comprises a compressed air canister, coupled to a valve controlled by the airflow controller, as described elsewhere herein;
the at least a first airflow generator comprises a pressurised reservoir, coupled to a valve controlled by the airflow controller, as described elsewhere herein;
   in this case, optionally the reservoir is pressurised by an electric pump, as described elsewhere herein;
      in this case, optionally the electric pump activates to pressurise the reservoir responsive to the audio signal's ability to mask the operation of the pump from the user, as described elsewhere herein;
the at least a first airflow generator comprises a bellows, driven by an actuator controlled by the airflow controller, as described elsewhere herein;
the at least first aspect of the audio signal comprises one or more selected from the list consisting of the amplitude of the audio signal, and the gradient of the audio signal, the airflow controller being configured to relate the at least first aspect to an airflow control signal, as described elsewhere herein;
   in this case, optionally the airflow controller is responsive to the least first aspect of the audio signal in dependence upon a voice activity detector, as described elsewhere herein;
the at least first aspect of the audio signal comprises one or more selected from the list consisting of lyrics associated with the audio signal, and phonemes associated with the audio signal, the airflow controller being configured to relate the at least first aspect to an airflow control signal, as described elsewhere herein;
   in this case, optionally the airflow controller is configured to relate the at least first aspect to an airflow control signal by reference to a respective database associating values of the at least first aspect to respective airflow control data, as described elsewhere herein;
the at least first aspect of the audio signal comprises airflow control data associated with the audio signal, as described elsewhere herein;
the airflow controller is configured to relate the at least first aspect to an airflow control signal by reference to a machine learning model previously trained to associate target airflow control signals within inputs comprising one or more selected from the list consisting of one or more representations of the audio signal, one or more representations of lyrics associated with the audio signal, and one or more representations of phonemes associated with the audio signal, as described elsewhere herein; and
the airflow controller (20) is located in one or more selected from the list consisting of the headphones (810), a videogame console (10), a music player, a smart TV, a smart phone or tablet, an amplifier or tuner, and a PC., as described elsewhere herein.

The audio reproduction system may thus comprise the headphones, and optionally (where the airflow control processor is external to the headphones), the device comprising the airflow control processor. The headphones and/or the device in turn may comprise the source of the audio signals, or may be part of a wider system comprising the source of the audio signals (or the local source, if ultimately received from a remote source). Typically this source is also a device such as a videogame console, a music player, a smart TV, a smart phone or tablet, an amplifier or tuner, and a PC., as described elsewhere herein.

As noted elsewhere herein, the audio reproduction system advantageously can provide airflow/puffs corresponding to one or more aspects of the reproduced audio that can trigger or heighten an ASMR experience for users disposed to such a response.

The foregoing discussion discloses and describes merely exemplary embodiments of the present invention. As will be understood by those skilled in the art, the present invention may be embodied in other specific forms without departing from the spirit or essential characteristics thereof. Accordingly, the disclosure of the present invention is intended to be illustrative, but not limiting of the scope of the invention, as well as other claims. The disclosure, including any readily discernible variants of the teachings herein, defines, in part, the scope of the foregoing claim terminology such that no inventive subject matter is dedicated to the public.

1. An audio reproduction system for reproducing an audio signal, comprising:
headphones, comprising in turn
at least a first loudspeaker; and
at least a first airflow generator configured to generate airflow toward a respective ear of a user of the headphones; and
an airflow controller, configured to control the airflow generated by the at least first airflow generator, responsive to at least a first aspect of the audio signal.

2. The audio reproduction system of claim 1, in which the at least a first airflow generator comprises a compressed air canister, coupled to a valve controlled by the airflow controller.

3. The audio reproduction system of claim 1, in which the at least a first airflow generator comprises a pressurised reservoir, coupled to a valve controlled by the airflow controller.

4. The audio reproduction system of claim 3, in which the reservoir is pressurised by an electric pump.

5. The audio reproduction system of claim 4, in which the electric pump activates to pressurise the reservoir responsive to an audio signal's ability to mask an operation of the pump from the user.

6. An audio reproduction system according to claim 1, in which the at least a first airflow generator comprises a bellows, driven by an actuator controlled by the airflow controller.

7. The audio reproduction system of claim 1, in which an at least first aspect of the audio signal comprises one or more selected from the list consisting of:
i. the amplitude of the audio signal; and
ii. the gradient of the audio signal,
the airflow controller being configured to relate the at least first aspect to an airflow control signal.

8. The audio reproduction system of claim 7, in which the airflow controller is responsive to the least first aspect of the audio signal in dependence upon a voice activity detector.

9. The audio reproduction system of claim 1, in which the at least first aspect of the audio signal comprises one or more selected from the list consisting of:
i. lyrics associated with the audio signal; and
ii. phonemes associated with the audio signal,
the airflow controller being configured to relate the at least first aspect to an airflow control signal.

10. The audio reproduction system of claim 9, in which the airflow controller is configured to relate the at least first aspect to an airflow control signal by reference to a respective database associating values of the at least first aspect to respective airflow control data.

11. The audio reproduction system of claim 1, in which the at least first aspect of the audio signal comprises airflow control data associated with the audio signal.

12. The audio reproduction system of claim 1, in which the airflow controller is configured to relate the at least first aspect to an airflow control signal by reference to a machine learning model previously trained to associate target airflow control signals within inputs comprising one or more selected from the list consisting of:
i. one or more representations of the audio signal;
ii. one or more representations of lyrics associated with the audio signal; and
iii. one or more representations of phonemes associated with the audio signal.

13. The audio reproduction system of claim 1, in which the airflow controller is located in one or more selected from the list consisting of:
i. the headphones;
ii. a videogame console;
iii. a music player;
iv. a smart TV;
v. a smart phone or tablet;
vi. an amplifier or tuner; and
vii. a PC.

14. A method of audio reproduction for reproducing an audio signal, comprising:
for headphones comprising in turn
at least a first loudspeaker; and
at least a first airflow generator configured to generate airflow toward a respective ear of a user of the headphones,
controlling the airflow generated by the at least first airflow generator, responsive to at least a first aspect of the audio signal.

15. A non-transitory, computer readable storage medium containing a computer program comprising computer executable instructions that when executed by a computer system, cause the computer system to perform a method of audio reproduction for reproducing an audio signal, comprising the step of:
for headphones comprising in turn
at least a first loudspeaker; and
at least a first airflow generator configured to generate airflow toward a respective ear of a user of the headphones,
controlling the airflow generated by the at least first airflow generator, responsive to at least a first aspect of the audio signal.
